(19) United States
(12) Patent Application Publication
(10) Pub. No.: US 2026/0350114 A1
(43) Pub. Date: Nov. 5, 2026

(54) SEASONALITY DRIFT DETECTION ALGORITHM

(71) Applicant: Oracle International Corporation, Redwood Shores, CA (US)

(72) Inventors: Debdatta Sinha Roy, Boston, MA (US); Kiran Venkata Panchamgam, Bedford, MA (US)

(73) Assignee: Oracle International Corporation, Redwood Shores, CA (US)

(21) Appl. No.: 19/569,681

(22) Filed: Mar. 17, 2026

Related U.S. Application Data
(60) Provisional application No. 63/798,390, filed on May 1, 2025.
(60) Provisional application No. 63/815,292, filed on May 30, 2025.

(51) Int. Cl. G06F 17/18; G06F 5/01; G06F 7/02

(52) U.S. Cl. CPC G06F 17/18; G06F 5/01; G06F 7/02

(57) ABSTRACT

The disclosed techniques address forecasting challenges in short-lifecycle data elements by detecting and adapting to concept drift—unpredictable changes in data patterns that degrade predictive accuracy. The described solution uses a multi-armed bandit (MAB) reinforcement learning framework, rather than traditional classification, to decide when to update the seasonality curve for each data element group. The process normalizes incoming data, groups elements, assigns initial seasonality curves, and updates them only if a computed reward metric falls below a threshold, balancing accuracy improvements with computational cost and budget constraints. These techniques update the statistical curves only when warranted, avoiding overreaction and unnecessary computation. Empirical results show these techniques outperform always updating or never updating policies, delivering higher reward and efficiency, especially in the presence of concept drift. Parameter choices, such as the update threshold and weighting of recent data, are selected to balance responsiveness and stability.

### CROSS-REFERENCES TO RELATED APPLICATIONS

This application claims the benefit of and priority to U.S. Provisional Application No. 63/798,390, filed on May 1, 2025, and U.S. Provisional Application No. 63/815,292, filed on May 30, 2025, which are both incorporated by reference in their entirety for all purposes. This application is also related to U.S. Non-Provisional application Ser. No. ______ (ORC25139887-US-NPR (RGIU #1), filed on ______, 2026, which is also incorporated by reference in its entirety for all purposes.

### BACKGROUND

With the advancement in machine learning, forecasting techniques have evolved over the years. However, all such techniques fundamentally depend on the ability to learn the seasonality patterns from the time series data. The forecasting techniques that work well for long-life cycle data elements (those that update values consistently throughout the year) are different from those that work well for short-life cycle data elements (those that update values during a specific season, or period of time).

For short-life cycle data elements, the key challenge is maintaining the quality of the seasonality curve if the weekly updates to the data element's values during the ongoing season show concept drift. Concept drift means that the statistical properties of the target variable, which the model is trying to forecast (or predict), change over time in unanticipated ways. If concept drift is present, the learned patterns from past data (historical seasonality patterns) may not be relevant to current circumstances, leading to poor predictions and decision outcomes. Typically, short-life cycle data elements only update values during a particular season.

Detecting concept drift is a challenging problem in the general machine learning technology space, especially when coupled with the need for an interpretable (causal) model. Unfortunately, none of the existing prediction processes helps detect seasonality concept drift.

### BRIEF SUMMARY

Some aspects of the present disclosure relate to techniques for detecting seasonality drift for data elements. The techniques can include receiving a plurality of values associated with respective data elements, normalizing the values associated with the data elements, grouping the data elements into a plurality of data element groups based at least in part on attributes associated with the data elements, assigning a statistical curve to each of the plurality of data element groups, determining, by the computing system, a comparison metric by comparing a first aggregate value for a group of the plurality of data element groups against a second aggregate value for the group of the plurality of data element groups, identifying whether the comparison metric exceeds a threshold value, and updating the statistical curve for the group of the plurality of data element groups in accordance with the comparison metric exceeding the threshold value.

In some embodiments, assigning a statistical curve to each of the plurality of data element groups could include generating an initial statistical curve for each group with aggregate values of the respective data elements in the data element group.

In some embodiments, updating the statistical curve for the group of plurality of data element groups may require prioritizing the plurality of data element groups and updating in accordance with a budget value that sets a limit on an amount of data element groups that can be updated. In additional embodiments, the plurality of data element groups is prioritized based at least in part on the aggregate values of the respective data elements for each of the plurality of data element groups.

In some embodiments, assigning a statistical curve to each of the plurality of data element groups is based at least in part on historical data for the respective data elements in each of the plurality of data element groups. In additional embodiments, assigning a statistical curve to each of the plurality of data element groups comprises augmenting the historical data of the respective data elements in each of the plurality of data element groups.

The plurality of values associated with respective data elements could correspond to occurrences of the data elements at different points in time. Additionally, attributes associated with the data elements could comprise hierarchical values and/or a start time.

### BRIEF DESCRIPTION OF THE DRAWINGS

FIG. 1 is a flowchart illustrating the seasonality-drift detection technique.

FIG. 2 is pseudocode illustrating one embodiment of the process for detecting seasonality drift and updating seasonality curves.

FIG. 3 is a table illustrating one embodiment of resulting data from the seasonality drift detection technique.

FIG. 4a is a chart illustrating one embodiment depicting how the sign of the total reward by data element group indicates that a data element group undergoes a sudden change in seasonality.

FIG. 4b is a graph illustrating one embodiment depicting how the technique updates the seasonality curve immediately after the shock.

FIG. 4c is a graph illustrating one embodiment depicting the best possible outcome for data element group 636.

FIG. 4d is a graph illustrating one embodiment depicting how the technique updates data element group 996's seasonality curve when the reward is a small negative value.

FIG. 4e is a graph illustrating one embodiment depicting how, while this is an efficient use of resources, updating at each timestep incurs a slightly larger reward than the technique.

FIG. 5a is a graph illustrating one embodiment of the actualized curves for the three policies for data element group 636.

FIG. 5b is a graph illustrating one embodiment of the actualized curves for the three policies for data element group 996.

FIG. 6 is a graph illustrating one embodiment of simulation results over a breadth of values for δ.

FIG. 7 is a table illustrating one embodiment of how overreactions are a concern with some cohorts of arms.

FIG. 8 is a table illustrating one embodiment where, if the initial curve is more accurate, then increased actions lead to more reward.

FIG. 9 is a block diagram illustrating an example computer system, in which various embodiments may be implemented.

### DETAILED DESCRIPTION

The ensuing description provides illustrative embodiment(s) only and is not intended to limit the scope, applicability or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

Forecasting is a vital part of data prediction: it impacts many aspects of strategy, allowing businesses and individuals to anticipate future outcomes, enabling better decision-making, resource allocation, and strategic planning. By analyzing historical data and identifying patterns, forecasting provides insights into potential risks and opportunities, allowing for proactive measures to be taken. This leads to improved efficiency, reduced costs, and ultimately, increased profitability.

These forecast models ingest large amounts of data (often for many data elements and over many years). Here, short lifecycle data elements are considered, meaning that each individual data element actively updates its values for a relatively short time period. Although shifts in these data elements often occur, many state-of-the-art techniques are not designed to handle unforeseeable changes in the underlying distribution of streaming data over time.

Concept drift means that the statistical properties of the target variable, which the model is trying to predict, change over time in unanticipated ways. If concept drift is present, the learned patterns from past data may not be relevant to current circumstances, leading to poor predictions and decision outcomes.

The disclosed techniques describe the problem of detecting concept drift in seasonality and of updating the seasonality coefficients of the forecast without overreacting or wasting computational resources. Detecting concept drift is a challenging problem in the general machine learning literature, especially when coupled with the need for an interpretable (i.e., causal) model. In addition, time-series prediction problems have specific challenges to overcome, such as the short length of each time series, and the existence of non-stationarities and non-normalities in the dataset. The space of time series prediction models are understudied in the machine learning literature. The disclosed techniques are designed for scalability, enabling practical deployment across forecasting universes comprising millions to hundreds of millions of SKU/store combinations, as commonly encountered in large-scale retail operations. While described primarily in the context of demand forecasting, the disclosed techniques are equally applicable to related retail decision-making processes, such as inventory optimization, dynamic pricing and markdown strategies, and product recommendation systems, wherever the accuracy of seasonality curves is impactful.

Described is a stepwise framework for updating seasonality. Some embodiments include a multi-armed bandit (MAB) model that is constructed with the time-series specific challenges in mind. The model has inherent flexibility in choice of measurement for concept drift, and treats budgetary constraints separately from the risks of overfitting. Additional embodiments include techniques for generating a policy of actions. Further embodiments may include a method for estimating the seasonality curve of a short-lifecycle data element with impartial timeseries information using historical data and the multiplicative Holt-Winters algorithm with an optional weighting parameter. In certain embodiments, the disclosed policy for updating seasonality curves is deterministic and requires no model training. Given identical input data, the system may always produce identical outputs, thereby enhancing trust, auditability, and ease of deployment in production environments.

Essentially, the problem is: given streaming aggregated transaction data for a set of distinct active data element groups, to determine whether to change the forecast model's assigned seasonality curve for each data element, and if yes, determine what the new seasonality curve should be. The choice of whether or not to update should be based on (a) whether (and to what extent) the update would improve the model predictions and (b) the computational cost of updating the model. In some examples, the method operates on standard sales, pricing, and inventory data already available in existing forecasting systems, obviating the need for additional data collection or new data sources.

Another way to view the problem of detecting and adapting to concept drift is as classifying whether or not to update the seasonality curve. Recall that the objective of classification problems is to learn parameters θ that characterize some algorithm ƒ(⋅), such that for all training data (Xᵢ; Yᵢ), ƒ_{θ}(Xᵢ)=Yᵢ+∈ᵢ. Then at test time, the planner uses the trained function ƒ_{θ} for all incoming data X′ to obtain Y′. The target variable Yᵢ represents a binary classification of whether or not to update the seasonality curve of data element i. Alternatively, the planner can admit Yᵢ∈[0, 1] to measure the importance or confidence of this assessment.

The planner then decides whether or not to update the seasonality curve at each timestep, so a classifier would generate multiple decisions

$${y}_{t}^{i} ,$$

each time incrementally utilizing more information to estimate the true seasonality curve. A key consideration for the planner is whether or not to update the seasonality curve now, or to wait for future timesteps. This is a nontrivial problem, and easier to handle with reinforcement learning than with classification.

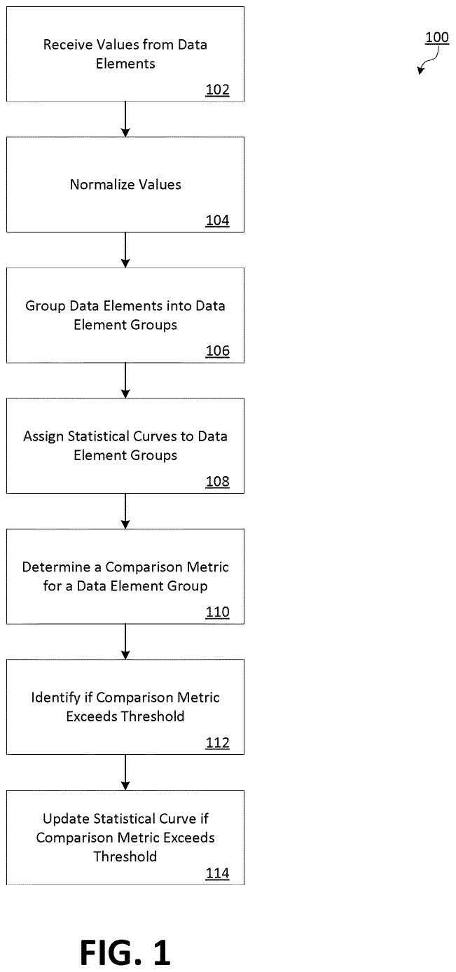

With reference now to FIG. 1, a flowchart illustrating the seasonality-drift technique 100 is shown. The problem may be modeled using multi-armed bandits (MABs), a type of reinforcement learning approach. Rather than develop a classification model to label whether or not concept drift has occurred, the focus is on utilizing positive or negative feedback from each data element group arm at each timestep to time strategic updates across data element group arms. At each timestep, the agent will choose whether or not to update the seasonality curve (equivalently, whether or not to “pull” the “arm”). The agent's goal is to maximize cumulative reward over T∈ [symbol] ⁺ timesteps, sometimes subject to budget constraints.

Each arm has an initially-assigned seasonality curve. In this model, the space of actions is restricted to two options at each timestep: either (a) don't update the seasonality curve, in which case

$${a}_{t}^{i}$$

is the seasonality curve currently assigned to the data element group i, or (b) update the seasonality curve, in which case the agent estimates the seasonality curve from its observations of the state and available exogenous information.

At block 102, values from data elements are received. In some embodiments, the technique receives input data comprising a plurality of data elements, which may be structured as records, fields, or any other data organization. Each data element may correspond to a numerical, categorical, or otherwise quantifiable value and may be comprised of several attributes that also correspond to a numerical, categorical, or otherwise quantifiable value. Different data elements may have different attributes or associated values.

There may be relatively few timesteps of data available before the learning technique needs to start making reliable, robust decisions. The application should ensure that the seasonality coefficients are reliable while the data element is still active. The technique should also be accurate when the data elements are making lots of updates, which may be towards the beginning of a data element's lifecycle. Thus, in some embodiments, the data used to generate a seasonality curve for a short lifecycle data element may be augmented.

At block 104, the values are normalized. In many data processing environments, data elements are collected from disparate sources or generated under varying conditions, resulting in heterogeneity (differences, diversity, or lack of uniformity) in the values and formats of such elements. This heterogeneity can impede accurate analysis, aggregation, and comparison of data. Normalization refers to the process of adjusting the values of data elements to conform to a common scale, range, or format, thereby enhancing the interoperability and interpretability of the data.

The technique is configured to analyze the distribution, range, and data type of each element to select an appropriate normalization strategy. For example, numerical values may be normalized using linear scaling techniques, such as min-max normalization, which rescales values to a specified range (e.g., 0 to 1), or z-score normalization, which adjusts values based on the mean and standard deviation of the dataset. For categorical data, normalization may include the mapping of values to standardized codes or indices.

In the context of retail sales data, normalization further comprises adjusting for price elasticity of demand. For short-lifecycle products, price elasticity is not static, but varies over the product lifecycle—typically exhibiting higher sensitivity during the initial peak sales phase and lower sensitivity during the markdown-driven long tail. Accordingly, the normalization process dynamically adjusts sales values to account for these varying elasticity effects, ensuring that the resulting time series more accurately reflects underlying seasonality rather than price-induced demand fluctuations.

Normalization may be performed in real time or as a batch operation. The techniques may further handle exceptions, such as outliers, missing values, or data anomalies, ensuring that normalization does not compromise data integrity. For example, if the values associated with a data element have undergone an extraordinary and influential fluctuation for a short period of time, but explainable through some unique and non-recurring events, that time data may be replaced with data that follows the traditional patterns of the data element.

In some embodiments, the process for handling disturbance periods-such as store closures, severe weather events, or other operational anomalies-does not merely remove the affected data points from the time series. Rather, the system replaces the data for the disturbance period with statistically derived artificial values or applies smoothing techniques to preserve the continuity and integrity of the time series. This approach ensures that temporal relationships are maintained and that the forecasting model retains awareness of event timing, which helps with providing accurate seasonality analysis.

At block 106, the data elements are grouped into data element groups. Because a statistical curve will be assigned to each group, deciding how the data elements are grouped is worth consideration. The number of active data elements in each group i may vary.

Some embodiments may group similar data elements together. That is, the problem is addressed not for each distinct active data element separately, but to assign one seasonality curve for a group of data elements. As long as there is sufficient historical data for the group of data elements, the set of data elements can be arbitrarily small. In some embodiments, sets of data elements can consist of just 3 active data elements.

In other embodiments, data elements may be grouped with neighboring data elements (according to some latent space of the data elements). However, since the core of the problem is to identify concept drift, it cannot be assumed that neighboring data elements share the same seasonality curve. If this assumption is reasonable, it is recommended to group the data elements together to get one seasonality curve. This highlights a second challenge that prevents the development of a classification learning technique. While grouping based on latent space representations or embeddings may be considered, it is important that any such groupings respect the expectations that all members of a group share a common seasonality curve. In practice, groupings based on explicit business rules, product hierarchy, and season start time are often preferable, as improper groupings may obscure concept drift or dilute statistical confidence.

Each arm i∈[N] in the MAB represents a categorical data element group. The state of an arm i at timestep t is the total number of updates,

$${s}_{t}^{i} ∈ {ℝ}^{+} ,$$

and the number of active data elements (so that the average number of updates is also computable). For each arm, the following exogenous variables are also required: (a) an initially-assigned seasonality curve, (b) two historical consecutive years of data (2T data points), and (c) the total of the values over the active data elements. However, note that the goal of the problem is to generate a seasonality curve for each data element group i, therefore, group membership should be based on the belief that the data elements share a seasonality curve. There are no assumptions about the distribution of arms-arms can be sampled from any distribution of data.

At block 108, statistical curves are assigned to each data element group. Actions are seasonality curves. At each timestep t, for each arm i, the agent may take an action

$${a}_{t}^{i} ∈ {ℝ}^{+ T} .$$

Seasonality is defined as periodic temporal variations in the state of an arm. Every seasonality coefficient is nonnegative, and the coefficients are normalized such that they sum to equal the length of the curve, T.

Transitions between states, P(s)=s′ are deterministic, independent of action, and unknown. The model does not attempt to parameterize or assume the sampling of states comes from some underlying distribution. The only constraint on transitions is that the sum of the values equals the total value for the group,

$${\sum }_{t} {s}_{t}^{i} = {n}^{i} ,$$

and that values are nonnegative.

Reward,

$$R ( {s}_{t}^{i} , {a}_{t}^{i} ) = {r}_{t}^{i} ∈ ℝ ,$$

is dependent on action as well as state. For each arm i, the reward at t can be broken up into steps. First, the environment approximates the ground-truth seasonality curve using observed data up to t. Then this curve is compared against the assigned curve. Let

$${y}_{t}^{i} ∈ ℝ$$

represent the comparison output (larger values are better). Finally,

$${r}_{t}^{i} := {ω}_{t} ( {y}_{t} - {y}_{t - 1} ) , {ω}_{t} := {s}_{t}^{i} / {n}^{i} .$$

The agent's goal is to maximize cumulative reward, which is an episodic problem with small finite horizon T.

At block 110, a comparison metric is determined for an individual data element group. There are a couple of options for comparing x_{assign}∈ [symbol] ^{+T}, the assigned seasonality curve of an arm, against x_{obs}∈ [symbol] ^{+T}, the observed approximation of the true seasonality curve. Some embodiments use correlation: correlation measures the linear relationship between the two variables. Recall that correlation is in the range [−1,1] (in fact, likely between (0,1] for this comparison), so it is straightforward to understand the magnitude of reward using this method.

Other embodiments measure the relative entropy between the two probability distributions with Kullback-Leibler (KL) divergence. Kullback-Leibler (KL) divergence, also referred to as relative entropy, is a fundamental measure from information theory that expresses the amount of information lost when one probability distribution is used to approximate another. Since the objective would be to minimize KL divergence, the value is negated to obtain a maximization objective.

At block 112, the comparison metric is compared to a threshold, and at block 114, the statistical curve is finally updated if the comparison metric exceeds the threshold. One type of forecasting technique, Seasonality Concept Adaptation Algorithm for Retail Forecasting (SCAARF) is a deterministic heuristic policy. This policy does not update the seasonality curve unless the reward is less than −τ. τ∈ [symbol] ⁺ is a threshold parameter; since the reward is computed with correlation, τ∈[0, 1]. If τ=1, the forecasting technique would never update an arm. The smaller t, the more likely the proposed forecasting technique is to update the seasonality curve. However, the forecasting technique only acts if the observations are worse than the previous timestep (as indicated by negative reward).

In some embodiments further include a budgetary constraint in addition to maximizing reward: the agent can pull at most a maximum number of arms at each timestep. Thus, the statistical curve would only be updated if the budget permits. Further embodiments consider fixed cost to update an arm. However, if for some reason the cost of updating arms varies, it is possible to assign different costs in this framework. The computational cost or budget for updating a statistical curve is not required to be uniform across all groups or time periods. In certain embodiments, the system may assign distinct costs to different data element groups or vary the budget constraint over time, thereby providing operational flexibility to fit diverse retail environments and resource constraints.

Due to the budgetary constraint on simultaneous actions in a given timestep t, the forecasting technique prioritizes actions based on

$${ω}_{i} := {s}_{t}^{i} / {\sum }_{i} {s}_{t}^{i} .$$

This is because it is more important to improve the seasonality curve of relatively active data elements (that frequently update their values).

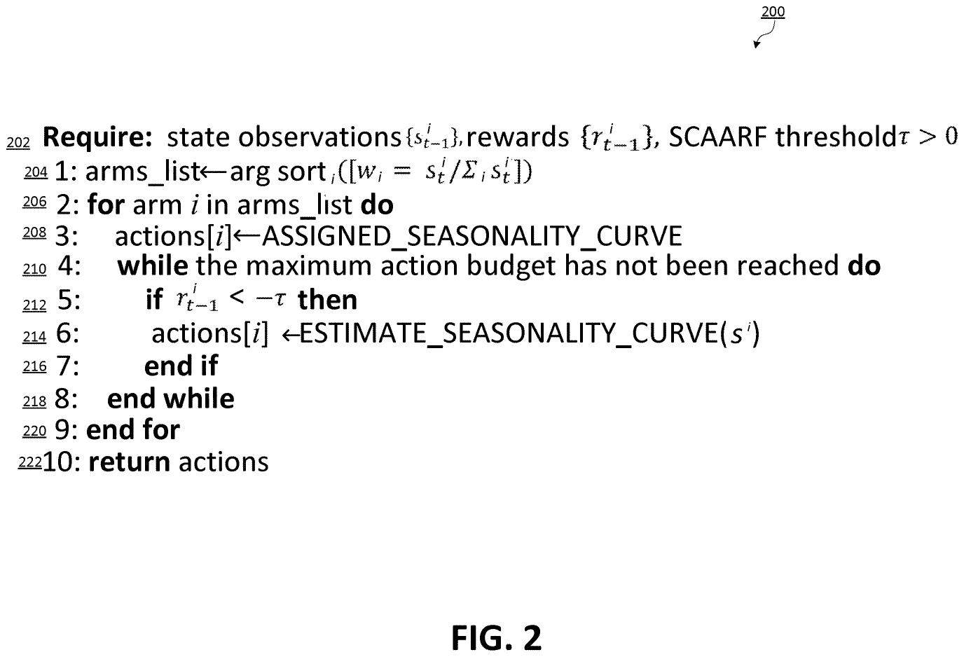

With reference now to FIG. 2, pseudocode 200 illustrating one embodiment of a process for detecting seasonality drift and updating seasonality curves is shown. The algorithm requirements are listed in line 202. The process accepts the state observations, the reward values for each state observation, and a threshold τ>0. The algorithm concludes at line 222 by returning the list of actions, or seasonality curves, for each arm. Notably, the SCARF policy is fully deterministic and operates without the need for model training or parameter learning, allowing for immediate, repeatable integration into forecasting workflows.

At line 204, the arms are sorted based on ωᵢ. The arms list contains the set of all groups/arms. At line 206, a loop begins and iterates over each arm within the arms list. This loop ends at line 220.

At line 208 (within the loop iterating over each arm in the arms list), an initial assigned seasonality curve is allocated to the current arm from the arms list and represents the initial action for the given arm.

At line 210, another loop begins and iterates while the maximum budget has not yet been reached. This loop ends at line 218. Inside the loop (at line 212), the reward value r is compared against the threshold t. If reward r is less than −τ, the algorithm executes line 214 and estimates and assigns a new seasonality curve as the action for the given arm. After executing line 214, or if reward r is greater than −τ, the conditional statement ends at line 216.

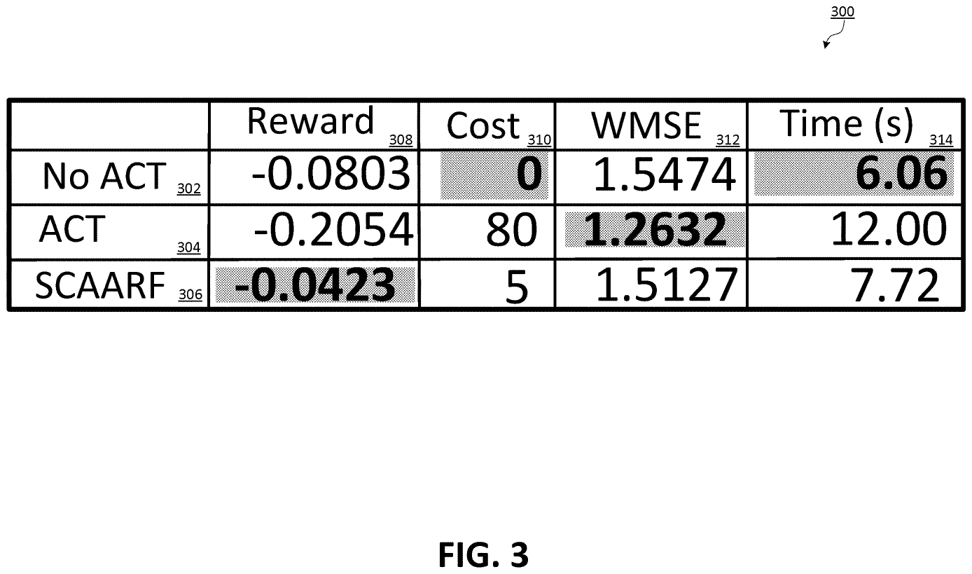

With reference now to FIG. 3, a table 300 illustrating one example of the resulting data from the seasonality drift detection technique is shown. Table 300 reports results on five data element groups that become active (start updating their values) during the same month (i.e., November). The best performing policy is highlighted for each metric. The values for the data elements are normalized but not smoothed.

In this embodiment, all active data element groups start within four timesteps of each other and contain at least two timesteps of initial consecutive value updates. Taken in aggregate, each group of data elements contains at least T=20 timesteps of data. Also in this embodiment, one-week elapses between timesteps, the “current” year is 2020, and the historic data comes from 2018 and 2019.

In some embodiments, the threshold is τ=0.01, the agent can update at most one seasonality curve at each timestep, and the initially assigned seasonality curve is taken from the database. Also in this embodiment, the Holt-Winters' weighting on new data is δ=0.9.

The proposed forecasting technique 306 is compared against two policies for reference: never updating (No Act 302) and always updating (Act 304), neither of which obey the maximum actions budget constraint. All policies wait four timesteps before acting.

The policies are evaluated on three primary outcome metrics: weighted total reward 308, total cost 310, and weighted mean squared error accuracy 312. For all outcome measures, if the comparison is made across timesteps then the weighting

$${ω}_{t} = {s}_{t}^{i} / {\sum }_{t} {s}_{t}^{i}$$

is applied. It the comparison is made across arms, then the weighting

$${ω}_{t} = {s}_{t}^{i} / {\sum }_{i} {s}_{t}^{i}$$

is applied. If the reward

$${r}_{t}^{i}$$

already has the scaling wₜ applied in its calculation.

$$Total weighted reward := {\sum }_{i = 1}^{N} {\sum }_{t = 1}^{T} {ω}_{i} {r}_{t}^{i} \\ Total cost := {\sum }_{i = 1}^{N} {\sum }_{t = 1}^{T} {a}_{t}^{i}$$

Let

$${\hat{x}}_{t}^{i}$$

be the seasonality coefficient assigned by the algorithm for data element i at time t, and let

$${x}_{t}^{i}$$

be the true seasonality coefficient, which is calculated after the simulation completes. Both curves are normalized to sum to T. Then the weighted mean squared error accuracy (WMSE) 312 is calculated as follows:

$$WMSE := \frac{1}{NT} \cdot {\sum }_{i = 1}^{N} {\sum }_{t = 1}^{T} ( \frac{{s}_{t}^{i}}{{\sum }_{i = 1}^{N} {s}_{t}^{i}} ) ( \frac{{s}_{t}^{i}}{{\sum }_{t = 1}^{T} {s}_{t}^{i}} ) {( {\hat{x}}_{t}^{i} - {x}_{t}^{i} )}^{2}$$

As seen in table 300, the proposed forecasting technique 306 obtains the best reward 308 with only five update actions. In contrast, Act 304, which updates the seasonality curve at each timestep, obtains 79.41% less reward 308. Act 304 also takes double the computational time 314 to compute relative to No Act 302 (although these results are reported for non-optimized Python code).

Therefore, the proposed forecasting technique 306 empirically obtains greater reward than No Act 302 (indicating that the proposed forecasting technique detects concept drift in the dataset and updates the seasonality curves accordingly). The proposed forecasting technique 306 also obtains greater reward than Act 304 (acting at every timestep), which means that the proposed forecasting technique 306 does not fall into the pitfalls of over-reacting. The cost 310 of using the proposed forecasting technique 306 is often far less than the budget (which may be tuned), and the time 314 required to compute the proposed forecasting technique 306 is very low.

The updated seasonality curves produced by the disclosed techniques are readily compatible with standard retail forecasting systems. As such, the outputs of the techniques may be directly integrated into existing demand planning, inventory management, and pricing optimization workflows, facilitating seamless adoption without requiring substantial system re-engineering.

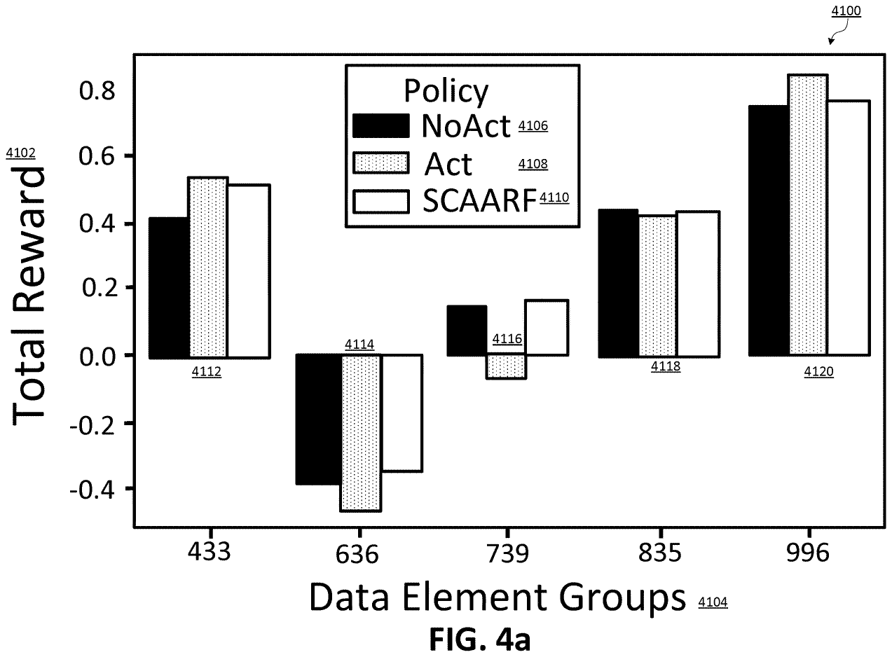

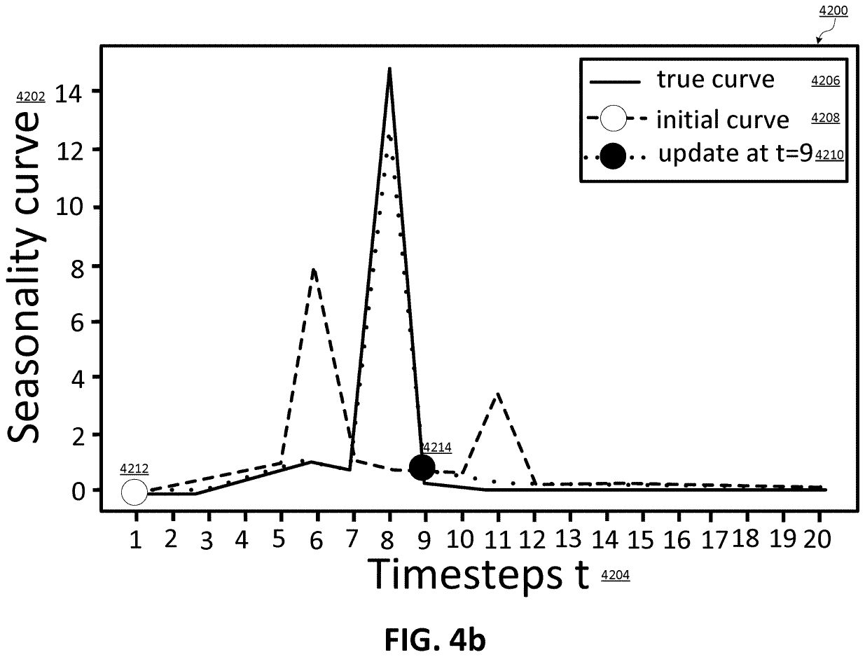

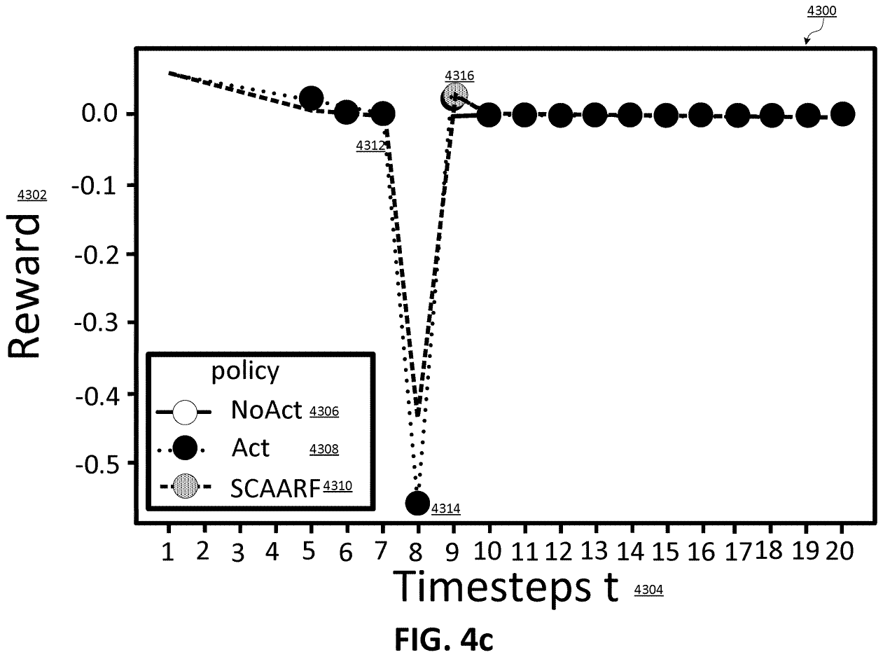

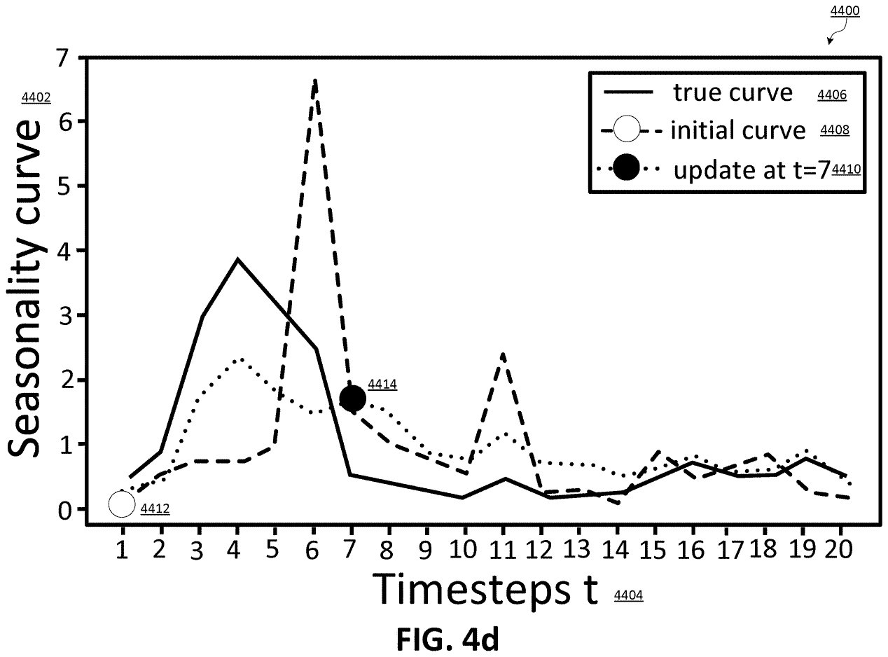

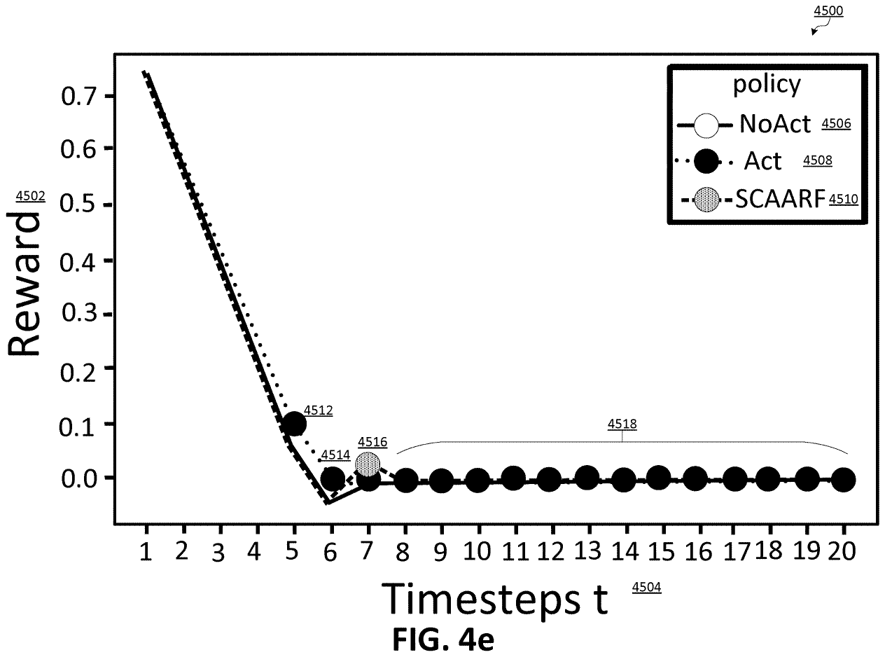

With reference now to FIG. 4a-e, a set of charts illustrating how reward measures weighted improvement in seasonality estimation is shown. Recall that reward measures weighted improvement in seasonality estimation, so it is surprising that all three techniques considered receive negative total weighted reward.

FIG. 4a is a chart 4100 depicting how the sign of the total reward by data element group indicates that data element group 636 (4114) undergoes a sudden change in seasonality. Chart 4100 shows the total reward 4102 for each data element group 4104 based on the three policies: No Act 4106, Act 4108, and the proposed forecasting technique (i.e., SCAARF) 4110. The total reward is positive for all three policies for data element groups 433 (4112), 835 (4118), and 996 (4120). For these three data element groups, Act 4108 (the policy that updates every data element group's seasonality curve at every timestep) receives more reward than No Act 4106 and the proposed forecasting technique 4110 (neither of which update the seasonality curve for these three data element groups). However, the Act technique's frequent updates have a detrimental effect on reward for data element groups 636 (4114) and 739 (4116). Both No Act 4106 and Act 4108 receive negative reward for data element group 636 (4114), which indicates that this data element group undergoes a sudden and unpredictable change in seasonality.

FIG. 4b is a graph 4200 depicting how the proposed forecasting technique updates the seasonality curve immediately after the shock. Graph 4200 plots the seasonality curve 4202 at each timestep t 4204. The initial seasonality curve 4208 assigned to this data element group at t=1 (4212) does not accurately represent the true seasonality curve 4206 of data element group 636. However, the true seasonality curve 4206 is unknown (and cannot be learned) before the full life-cycle of the data element group has ended. The proposed forecasting technique, however, updates the seasonality curve immediately after the divergence in timestep t=8. The updated seasonality curve 4210 closely matches the data element group's true seasonality. Note that the proposed forecasting technique does not update when the first divergence between assigned and observed seasonality is observed at t=7, but instead at t=9 (4214).

FIG. 4c is a graph 4300 depicting the best possible outcome for data element group 636. Graph 4300 plots the reward 4302 at each timestep t 4304. The reward per timestep is even worse for Act 4308, which also updates the seasonality curve immediately before the shock (4312). Because Act's premature update of seasonality results in reduced reward 4314, the proposed forecasting technique's decision not to update when the first divergence is observed at t=7 demonstrates that updating at t=9 (4316) is a wise decision.

FIG. 4d is a graph 4400 depicting how, in contrast, the proposed forecasting technique updates data element group 996's seasonality curve 4410 when the reward is a small negative value. Graph 4400 plots the seasonality curve 4402 at each timestep t 4404.

FIG. 4e is a graph 4500 depicting how, while this is an efficient use of resources, Act's frequent updates incur slightly larger reward than the proposed forecasting technique. Graph 4500 plots the reward 4502 at each timestep t 4504. Data element group 996 obtains positive reward, primarily due to the initial reward at t=1.

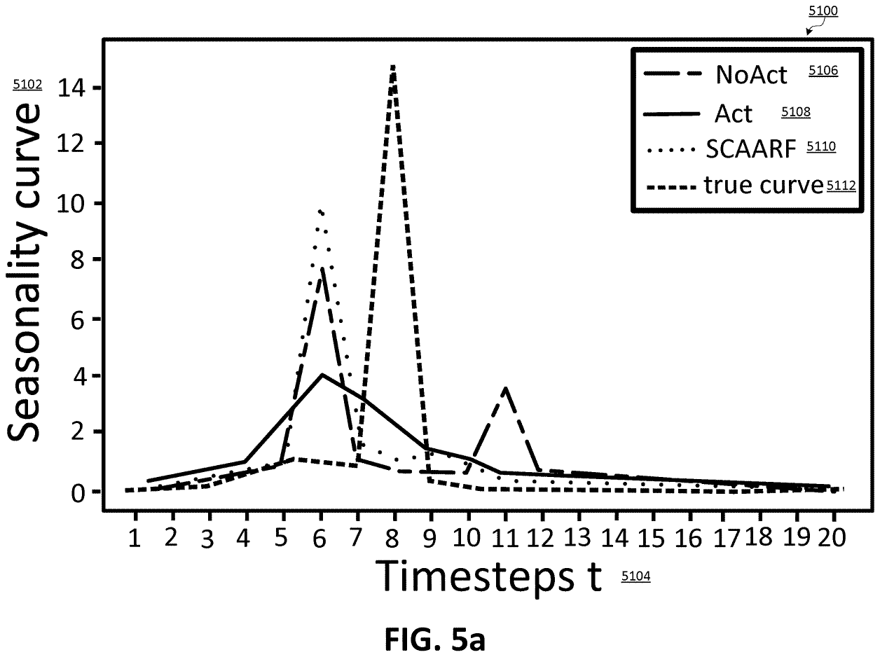

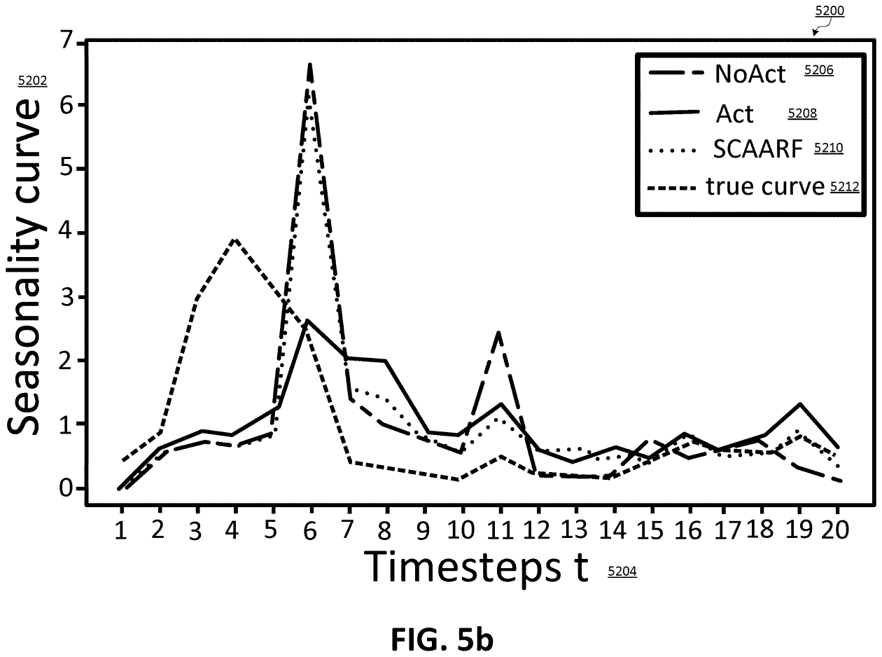

With reference now to FIG. 5a and FIG. 5b, graphs illustrating the actualized curves for the three policies for data element groups 636 and 996, respectively, are shown. Recall that updates to the seasonality curves are being applied to active data element groups. Therefore, it is interesting to consider the actualized seasonality curves 5106-5110/5206-5210—the seasonality coefficients that are actually utilized at each timestep. (To build intuition, note that the actualized curve of the No Act policy is simply the initially assigned curve).

FIG. 5a is a graph 5100 depicting the actualized curves for the three policies for data element group 636. Graph 5100 plots the seasonality curve 5102 at each timestep t 5104.

FIG. 5b is a graph 5200 depicting the actualized curves for the three policies for data element group 996. Graph 5200 plots the seasonality curve 5202 at each timestep t 5204.

Note that for both arms, the proposed forecasting technique 5110/5210 does just as well (or poorly) as Act 5108/5208. While matching the true curve 5112/5212 is not the agent's objective, it is of interest. In an online setting such as forecasting for the current ongoing season, these actualized seasonality coefficients are utilized at each timestep.

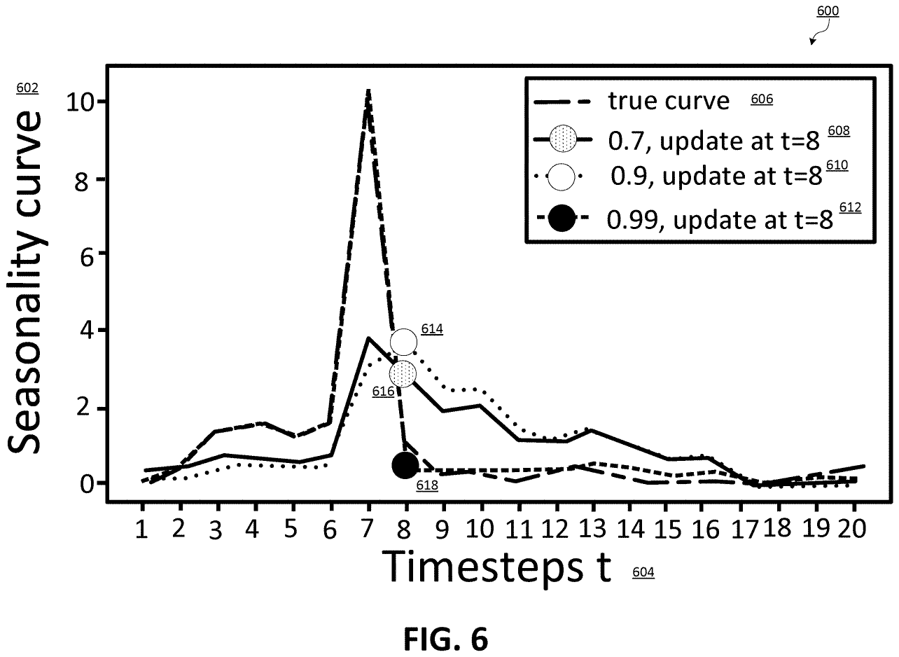

With reference now to FIG. 6, a graph 600 illustrating simulation results over a breadth of values for δ, and plots the seasonality curves post-update 608/610/612, as well as the ground-truth curve 606 for reference is shown. Graph 600 plots the seasonality curve 602 at each timestep t 604.

The weighting parameter δ is varied in the seasonality curve estimation step. In this embodiment, the threshold was τ=0.01, and the maximum number of actions was 1 per timestep.

Point 614 depicts an update to the seasonality curve 610 at t=8 for δ=0.9. Point 616 depicts an update to the seasonality curve 608 at t=8 for δ=0.7. Point 618 depicts an update to the seasonality curve 612 at t=8 for δ=0.99.

Note that there is no update when δ=0.5, so there is no associated line in the plot. This means that recent temporal changes in seasonality are less emphasized by the Holt-Winters' fitting algorithm. Therefore, no update is indicated because no concept drift is detected. As the values for δ increase, the accuracy of the updated seasonality curve 608/610/612 also increases. Thus, δ=0.99 (612) weights recent observations the most, and its seasonality curve closely matches the true curve 606.

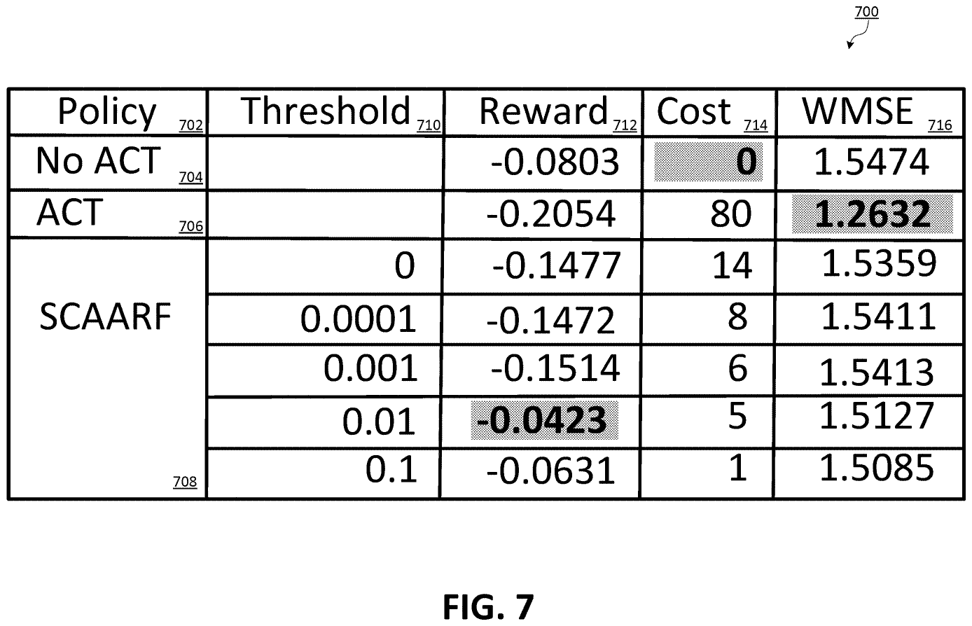

With reference now to FIG. 7, a table 700 illustrating how overreactions are a concern with some cohorts of arms is shown. Specifically, as the threshold 710 decreases, reward 712 also decreases. In this embodiment's set of numerical results, the threshold parameter 710 of the proposed forecasting technique 708 is varied. Recall that a large threshold 710 means that fewer actions are taken. Thus, the purpose of the threshold 710 is to limit overreactions to prevent decreases in reward 712. In the simulations for this embodiment, the maximum actions per timestep constraint is 1.

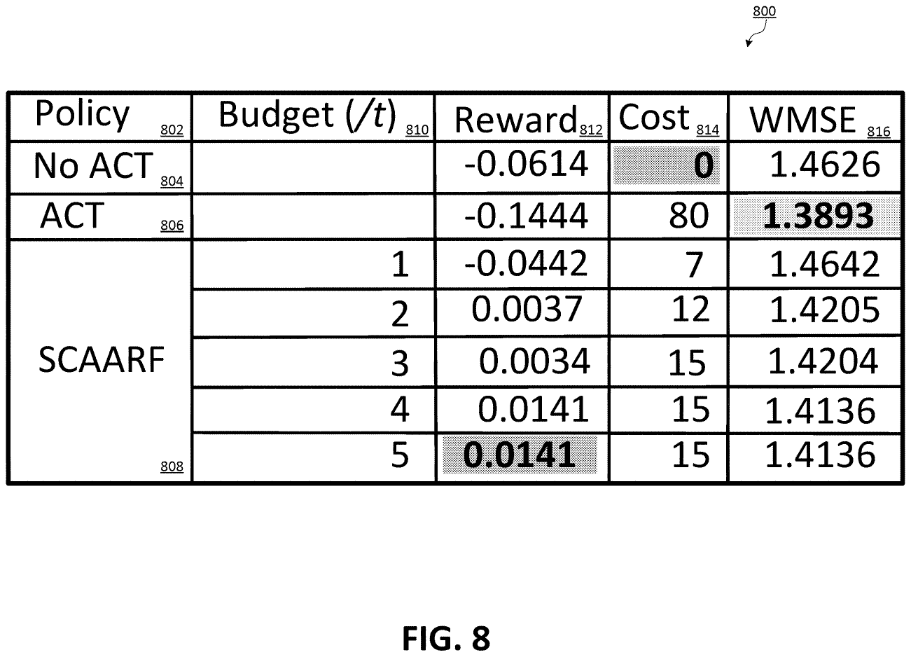

With reference now to FIG. 8, a table 800 illustrating that, if the initial curve is more accurate, then increased actions lead to more reward (for an appropriate threshold) is shown. Both the effects of varying the budget 810 and updating the initial curve are considered. The initial curve is updated to “equalize the playing field”—because, in this embodiment, there is concept drift in the primary dataset, there is no reason to use more budget 810 in the primary numerical results. To illustrate this effect, the threshold was reduced to τ=0.0001 to encourage more actions.

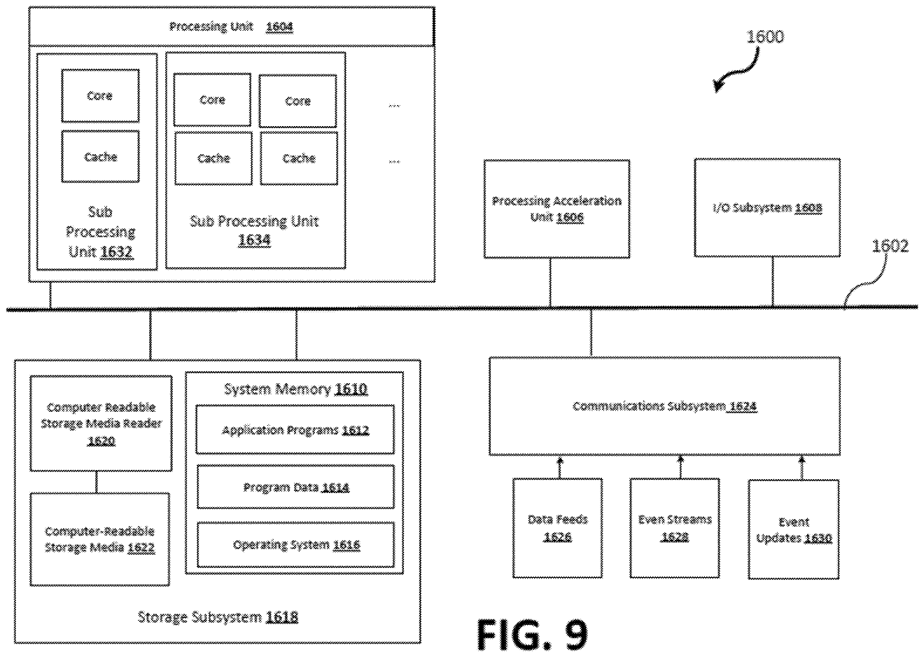

With reference now to FIG. 9, an example computer system 1600, in which various embodiments may be implemented, is shown. The system 1600 may be used to implement any of the computer systems described above. As shown in the figure, computer system 1600 includes a processing unit 1604 that communicates with a number of peripheral subsystems via a bus subsystem 1602. These peripheral subsystems may include a processing acceleration unit 1606, an I/O subsystem 1608, a storage subsystem 1618 and a communications subsystem 1624. Storage subsystem 1618 includes tangible computer-readable storage media 1622 and a system memory 1610.

Bus subsystem 1602 provides a mechanism for letting the various components and subsystems of computer system 1600 communicate with each other as intended. Although bus subsystem 1602 is shown schematically as a single bus, alternative embodiments of the bus subsystem may utilize multiple buses. Bus subsystem 1602 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1604, which can be implemented as one or more integrated circuits (e.g., a conventional microprocessor or microcontroller), controls the operation of computer system 1600. One or more processors may be included in processing unit 1604. These processors may include single core or multicore processors. In certain embodiments, processing unit 1604 may be implemented as one or more independent processing units 1632 and/or 1634 with single or multicore processors included in each processing unit. In other embodiments, processing unit 1604 may also be implemented as a quad-core processing unit formed by integrating two dual-core processors into a single chip.

In various embodiments, processing unit 1604 can execute a variety of programs in response to program code and can maintain multiple concurrently executing programs or processes. At any given time, some or all of the program code to be executed can be resident in processor(s) 1604 and/or in storage subsystem 1618. Through suitable programming, processor(s) 1604 can provide various functionalities described above. Computer system 1600 may additionally include a processing acceleration unit 1606, which can include a digital signal processor (DSP), a special-purpose processor, and/or the like.

I/O subsystem 1608 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1600 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1600 may comprise a storage subsystem 1618 that provides a tangible non-transitory computer-readable storage medium for storing software and data constructs that provide the functionality of the embodiments described in this disclosure. The software can include programs, code, instructions, scripts, etc., that when executed by one or more cores or processors of processing unit 1604 provide the functionality described above. Storage subsystem 1618 may also provide a repository for storing data used in accordance with the present disclosure.

As depicted in the example in FIG. 9, storage subsystem 1618 can include various components including a system memory 1610, computer-readable storage media 1622, and a computer readable storage media reader 1620. System memory 1610 may store program instructions that are loadable and executable by processing unit 1604. System memory 1610 may also store data that is used during the execution of the instructions and/or data that is generated during the execution of the program instructions. Various different kinds of programs may be loaded into system memory 1610 including but not limited to client applications, Web browsers, mid-tier applications, relational database management systems (RDBMS), virtual machines, containers, etc.

System memory 1610 may also store an operating system 1616. Examples of operating system 1616 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1600 executes one or more virtual machines, the virtual machines along with their guest operating systems (GOSs) may be loaded into system memory 1610 and executed by one or more processors or cores of processing unit 1604.

System memory 1610 can come in different configurations depending upon the type of computer system 1600. For example, system memory 1610 may be volatile memory (such as random access memory (RAM)) and/or non-volatile memory (such as read-only memory (ROM), flash memory, etc.). Different types of RAM configurations may be provided including a static random access memory (SRAM), a dynamic random access memory (DRAM), and others. In some implementations, system memory 1610 may include a basic input/output system (BIOS) containing basic routines that help to transfer information between elements within computer system 1600, such as during start-up.

Computer-readable storage media 1622 may represent remote, local, fixed, and/or removable storage devices plus storage media for temporarily and/or more permanently containing, storing, computer-readable information for use by computer system 1600 including instructions executable by processing unit 1604 of computer system 1600.

Computer-readable storage media 1622 can include any appropriate media known or

used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1622 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1622 may include, but is not limited to, Zip® drives, flash memory cards, universal serial bus (USB) flash drives, secure digital (SD) cards, DVD disks, digital video tape, and the like. Computer-readable storage media 1622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program services, and other data for computer system 1600.

Machine-readable instructions executable by one or more processors or cores of processing unit 1604 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1624 provides an interface to other computer systems and networks. Communications subsystem 1624 serves as an interface for receiving data from and transmitting data to other systems from computer system 1600. For example, communications subsystem 1624 may enable computer system 1600 to connect to one or more devices via the Internet. In some embodiments communications subsystem 1624 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1624 can provide wired network connectivity (e.g., Ethernet) in addition to or instead of a wireless interface.

In some embodiments, communications subsystem 1624 may also receive input communication in the form of structured and/or unstructured data feeds 1626, event streams 1628, event updates 1630, and the like on behalf of one or more users who may use computer system 1600.

By way of example, communications subsystem 1624 may be configured to receive data feeds 1626 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1624 may also be configured to receive data in the form of continuous data streams, which may include event streams 1628 of real-time events and/or event updates 1630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1624 may also be configured to output the structured and/or unstructured data feeds 1626, event streams 1628, event updates 1630, and the like to one or more databases that may be in communication with one or more streaming data source computers coupled to computer system 1600.

Computer system 1600 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1600 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environment, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
receiving, by a computing system, a plurality of values associated with respective data elements;
normalizing, by the computing system, the values associated with the data elements;
grouping, by the computing system, the data elements into a plurality of data element groups based at least in part on attributes associated with the data elements;
assigning, by the computing system, a statistical curve to each of the plurality of data element groups;
determining, by the computing system, a comparison metric by comparing a first aggregate value for a group of the plurality of data element groups against a second aggregate value for the group of the plurality of data element groups;
identifying, by the computing system, whether the comparison metric exceeds a threshold value; and
updating, by the computing system, the statistical curve for the group of the plurality of data element groups in accordance with the comparison metric exceeding the threshold value.

2. The method of claim 1, wherein updating the statistical curve for the group of plurality of data element groups also requires:
prioritizing the plurality of data element groups; and
updating in accordance with a budget value that sets a limit on an amount of data element groups that can be updated.

3. The method of claim 2, wherein the plurality of data element groups is prioritized based at least in part on aggregate values of respective data elements for each of the plurality of data element groups.

4. The method of claim 1, wherein the plurality of values associated with respective data elements correspond to occurrences of the data elements at different points in time.

5. The method of claim 1, wherein assigning a statistical curve to each of the plurality of data element groups is based at least in part on historical data for the respective data elements in each of the plurality of data element groups.

6. The method of claim 5, wherein assigning a statistical curve to each of the plurality of data element groups comprises augmenting the historical data of the respective data elements in each of the plurality of data element groups.

7. The method of claim 1, wherein the attributes associated with the data elements comprise hierarchical values.

8. The method of claim 1, wherein the attributes associated with the data elements comprise a start time.

9. The method of claim 1, wherein assigning a statistical curve to each of the plurality of data element groups comprises generating an initial statistical curve for each group with aggregate values of the respective data elements in the data element group.

10. A computer system, comprising:
one or more processors; and
one or more memories storing computer-executable instructions that, when executed by the one or more processors, cause the computer system to:
receive a plurality of values associated with respective data elements;
normalize the values associated with the data elements;
group the data elements into a plurality of data element groups based at least in part on attributes associated with the data elements;
assign a statistical curve to each of the plurality of data element groups;
determine a comparison metric by comparing a first aggregate value for a group of the plurality of data element groups against a second aggregate value for the group of the plurality of data element groups;
identify whether the comparison metric exceeds a threshold value; and
update the statistical curve for the group of the plurality of data element groups in accordance with the comparison metric exceeding the threshold value.

11. The computer system of claim 10, wherein updating the statistical curve for the group of plurality of data element groups also requires:
prioritizing the plurality of data element groups; and
updating in accordance with a budget value that sets a limit on an amount of data element groups that can be updated.

12. The computer system of claim 11, wherein the plurality of data element groups is prioritized based at least in part on aggregate values of respective data elements for each of the plurality of data element groups.

13. The computer system of claim 10, wherein the plurality of values associated with respective data elements correspond to occurrences of the data elements at different points in time.

14. The computer system of claim 10, wherein assigning a statistical curve to each of the plurality of data element groups is based at least in part on historical data for the respective data elements in each of the plurality of data element groups.

15. The computer system of claim 14, wherein assigning a statistical curve to each of the plurality of data element groups comprises augmenting the historical data of the respective data elements in each of the plurality of data element groups.

16. A non-transitory computer-readable medium storing instructions that, when executed by one or more processors of a computing system, cause the computing system to perform operations comprising:
receiving, by the computing system, a plurality of values associated with respective data elements;
normalizing, by the computing system, the values associated with the data elements;
grouping, by the computing system, the data elements into a plurality of data element groups based at least in part on attributes associated with the data elements;
assigning, by the computing system, a statistical curve to each of the plurality of data element groups;
determining, by the computing system, a comparison metric by comparing a first aggregate value for a group of the plurality of data element groups against a second aggregate value for the group of the plurality of data element groups;
identifying, by the computing system, whether the comparison metric exceeds a threshold value; and
updating, by the computing system, the statistical curve for the group of the plurality of data element groups in accordance with the comparison metric exceeding the threshold value.

17. The computing system of claim 16, wherein updating the statistical curve for the group of plurality of data element groups also requires:
prioritizing the plurality of data element groups; and
updating in accordance with a budget value that sets a limit on an amount of data element groups that can be updated.

18. The computing system of claim 17, wherein the plurality of data element groups is prioritized based at least in part on aggregate values of respective data elements for each of the plurality of data element groups.

19. The computing system of claim 16, wherein the plurality of values associated with respective data elements correspond to occurrences of the data elements at different points in time.

20. The computing system of claim 16, wherein assigning a statistical curve to each of the plurality of data element groups is based at least in part on historical data for the respective data elements in each of the plurality of data element groups, and wherein assigning a statistical curve to each of the plurality of data element groups comprises augmenting the historical data of the respective data elements in each of the plurality of data element groups.
